(19) United States
(12) Patent Application Publication
(10) Pub. No.: US 2023/0030971 A1
(43) Pub. Date: Feb. 2, 2023

(54) SILICON GERMANIUM-BASED SEMICONDUCTOR-INSULATOR-SEMICONDUCTOR CAPACITOR (SISCAP) MODULATOR

(71) Applicant: Cisco Technology, Inc., San Jose, CA (US)

(72) Inventors: Vipulkumar K. PATEL, Breinigsville, PA (US); Ming Gai Stanley LO, Breinigsville, PA (US); Xunyuan ZHANG, Mechanicsburg, PA (US)

(21) Appl. No.: 17/443,891

(22) Filed: Jul. 28, 2021

(51) Int. Cl. G02F 1/225; G02F 1/015

(52) U.S. Cl. CPC G02F 1/2257; G02F 1/0152

(57) ABSTRACT

Embodiments presented in this disclosure generally relate to optical signal processing. More specifically, embodiments disclosed herein are directed to a semiconductor-insulator-semiconductor capacitor (SISCAP) modulator. One embodiment includes an optical modulator having a capacitive element configured to modulate an optical signal. The capacitive element includes a single-crystal semiconductor layer, a silicon germanium layer, and a dielectric region between the single-crystal semiconductor layer and the silicon germanium layer.

### TECHNICAL FIELD

Embodiments presented in this disclosure generally relate to optical signal processing. More specifically, embodiments disclosed herein are directed to a semiconductor-insulator-semiconductor capacitor (SISCAP) modulator.

### BACKGROUND

A semiconductor-insulator-semiconductor capacitor (SISCAP) modulator is an important element of silicon photonics platforms. In the current generation of SISCAP modulators, a waveguide is created using the geometry having a silicon layer, gate oxide, and polysilicon layer. The silicon and polysilicon layers are doped with opposite polarity dopants and with application of an appropriate voltage, charge may be depleted or accumulated on sides of the gate oxide, thus changing the refractive index (e.g., free carrier plasma dispersion effect) associated with the SISCAP modulator to modulate an optical signal. Using a polysilicon layer adversely impacts the speed (e.g., bandwidth) of the SISCAP modulator due to the high resistance associated with polysilicon and also contributes additional optical loss due to lower mobility and grain boundary scattering.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates an example semiconductor-insulator-semiconductor capacitor (SISCAP) device.

FIGS. 2A and 2B illustrate an example implementation of a SISCAP device and an equivalent circuit of the SISCAP device, respectively.

FIGS. 3A and 3B illustrate another example implementation of a SISCAP device having four contacts and an equivalent circuit of the SISCAP device, respectively.

FIG. 4 illustrates another example implementation of a SISCAP device having a single-crystal semiconductor layer implemented using both silicon material and silicon germanium material.

FIG. 5 is a flow diagram illustrating example operations for optical modulation.

### DESCRIPTION OF EXAMPLE EMBODIMENTS

### Overview

One embodiment presented in this disclosure provides an optical modulator. The optical modulator generally includes a capacitive element configured to modulate an optical signal, the capacitive element comprising a single-crystal semiconductor layer, a silicon germanium layer, and a dielectric region between the single-crystal semiconductor layer and the silicon germanium layer.

One embodiment presented in this disclosure provides a method for optical modulation. The method generally includes providing an optical signal to a capacitive element, and modulating the optical signal by applying a modulation signal to the capacitive element, wherein the capacitive element comprises a single-crystal semiconductor layer, a silicon germanium layer, and a dielectric region between the single-crystal semiconductor layer and the silicon germanium layer.

One embodiment presented in this disclosure provides an apparatus for optical modulation. The apparatus generally includes a capacitive element having a single-crystal semiconductor layer, a silicon germanium layer, and a dielectric region between the single-crystal semiconductor layer and the silicon germanium layer, an optical component configured to provide an optical signal to the capacitive element, and a modulation component configured to modulate the optical signal by applying a modulation signal to the capacitive element.

### EXAMPLE EMBODIMENTS

Some embodiments of the present disclosure are directed to an optical modulator implemented using a semiconductor-insulator-semiconductor capacitor (SISCAP), where the SISCAP has a single-crystal semiconductor layer, a silicon germanium (SiGe) layer (e.g., a polycrystalline SiGe layer), and a dielectric region (e.g., gate oxide) between the single-crystal semiconductor layer and the SiGe layer. The performance of an optical modulator (e.g., SISCAP modulator) relies on charge accumulation in a capacitor (also referred to herein as a capacitive element) configuration around the gate oxide. A local change in refractive index around the gate oxide results in a phase shift of the optical signal, allowing for optical signal modulation.

Two factors drive a silicon-based optical phase modulator's performance. The first factor includes the overlap of an optical mode with a charge modulation region of the SISCAP device. In other words, the SISCAP structure is more efficient with a greater overlap between charge and optical intensity. A second factor includes having a low electrical resistance and optical loss. Higher resistance of a SISCAP device results in a lower bandwidth for the SISCAP device. One contributor to the high electrical resistance of the SISCAP device is the high series resistance associated with polysilicon used in typical SISCAP devices. Polysilicon gate resistance can be reduced by increasing the polysilicon doping, but increasing the doping may result in greater optical loss (e.g., free-carrier absorption). In other words, as compared to single-crystal silicon, reducing the series resistance of a polysilicon layer may involve using higher doping levels which results in additional optical losses. Certain embodiments of the present disclosure are directed techniques for reducing the resistance associated with the SISCAP device by using a SiGe layer while avoiding increased optical losses.

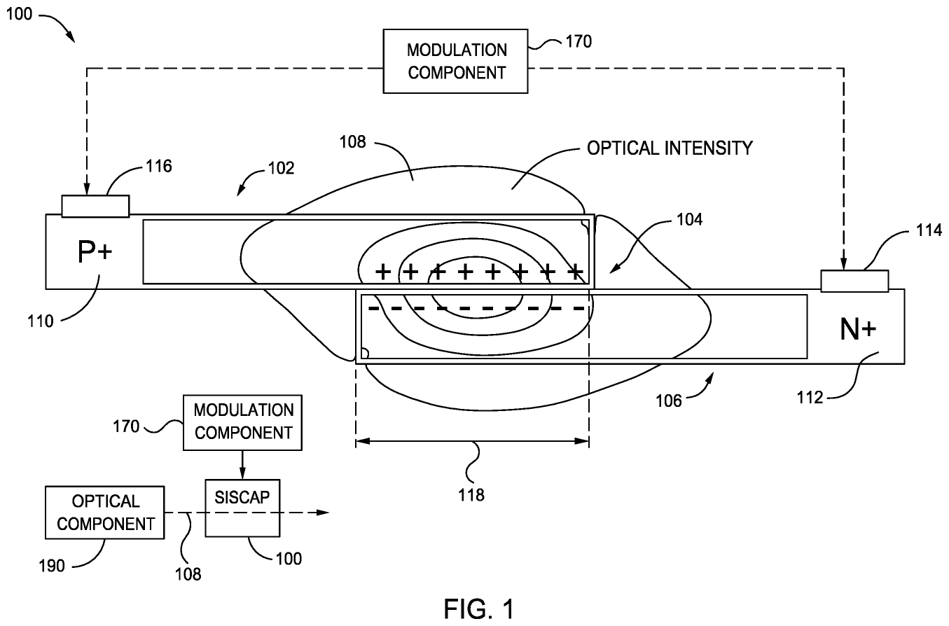

FIG. 1 illustrates an example SISCAP device 100 having a top layer 102 (e.g., a polycrystalline SiGe layer), a dielectric region 104 (e.g., a thin gate oxide), and a bottom layer 106 (e.g., a single-crystal semiconductor layer). Due to the lower resistance associated with SiGe compared to polysilicon, the resistance associated with the SISCAP device 100 may be reduced compared to conventional implementations.

As described, SISCAP modulator performance relies upon charge accumulation in the capacitor (e.g., around the gate oxide, as shown). For example, a modulation component 170 may apply a modulation signal across contacts 114, 116. As a result, a positive charge may accumulate in the SiGe layer 102 and a negative charge may accumulate (e.g., charge is depleted from layer 106) in the single-crystal semiconductor layer 106, as shown. The accumulation of the positive and negative charges depends on the applied modulation signal. With the application of the modulation signal, both sides of the dielectric region 104 are either depleted or accumulated, thus changing the refractive index associated with the SISCAP device and modulating the optical intensity of an optical signal 108 applied by an optical component 190, as shown.

In some cases, a portion of each of layers 102, 106 may overlap, forming a SISCAP modulator having a SISCAP modulator width 118. A highly positive doped region 110 (e.g., P+ region) may be implemented for layer 102 for coupling to contact 116, and a highly negative doped region 112 may be implemented for layer 106 for coupling to contact 114, to facilitate the application of the modulation signal as described. While the example SISCAP device 100 is implemented with the top layer 102 being P doped and the bottom layer 106 being N doped to facilitate understanding, the aspects described herein may be implemented with the top layer 102 being N doped and the bottom layer 106 being P doped.

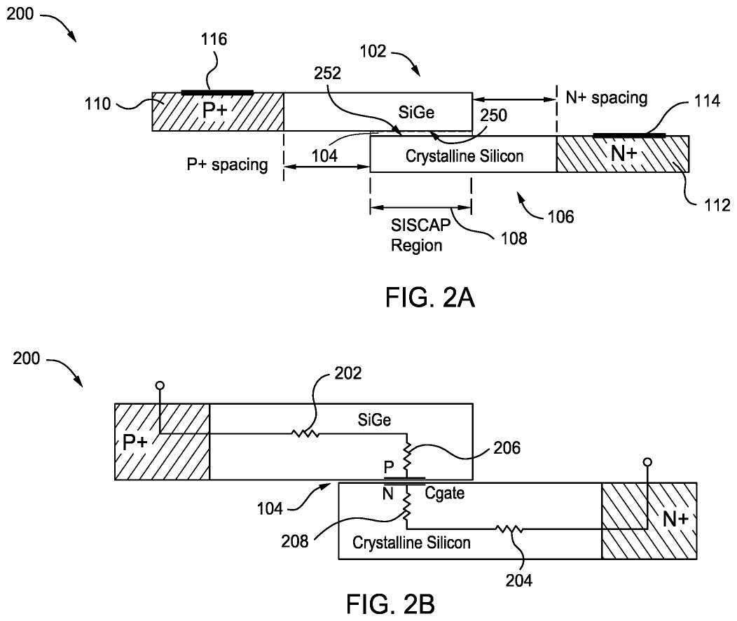

FIGS. 2A and 2B illustrate an example implementation of a SISCAP device 200 and an equivalent circuit of the SISCAP device 200, respectively. As shown, the dielectric region 104 includes a side 250 and a side 252. A portion of layer 102 adjoins side 250 of the dielectric region 104, and a portion of layer 106 adjoins side 252, as shown.

As shown in FIG. 2B, layer 102 includes a series resistance having a resistance component 202 and a gate resistance component 206. Similarly, layer 106 includes a series resistance having a resistance component 204 and a gate resistance component 208. The bandwidth of the SISCAP device is a function of the series resistances of the layers 102, 106, as well as the capacitance (Cgate) associated with the gate oxide and parasitic capacitances of the SISCAP device.

The product of the series resistance associated with the SISCAP device and the capacitance Cgate is referred to as the resistor-capacitor (RC) time constant of the SISCAP device. An increase in the series resistance may increase the RC time constant of the SISCAP device, reducing the bandwidth of the SISCAP device, and vice versa. Therefore, by implementing layer 102 using SiGe material, the series resistance of the SISCAP device may be reduced, reducing the RC time constant and increasing the bandwidth of the SISCAP device. In other words, by implementing layer 102 as a SiGe layer, the series resistance associated with layer 102 may be reduced due to the higher free carrier mobility associated with SiGe as compared to polysilicon. Reducing the resistance increases the SISCAP device's bandwidth compared to conventional implementations where the top layer of the SISCAP device is implemented using a polysilicon layer.

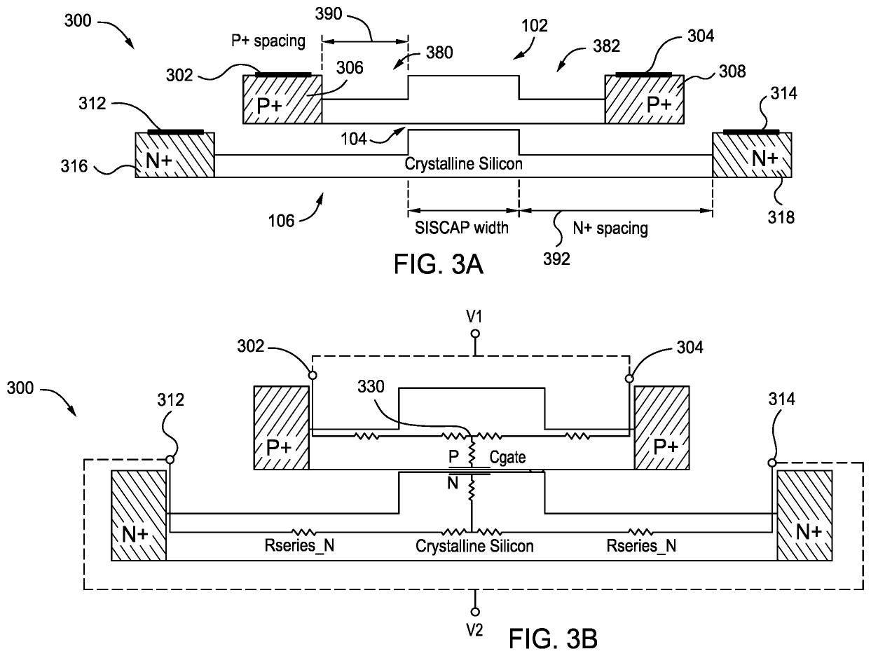

FIGS. 3A and 3B illustrate another example implementation of a SISCAP device 300 and an equivalent circuit of the SISCAP device 300, respectively. As shown, the SISCAP device 300 may be implemented with two contacts 302, 304 coupled to the highly positive doped regions 306, 308 of layer 102, respectively. The SISCAP device 300 also includes two contacts 312, 314 coupled to highly negative doped regions 316, 318 of layer 106, respectively.

Using the two contacts for layer 102 results in a reduction of the effective series resistance for layer 102 (e.g., by about a quarter) as compared to the series resistance of layer 102 in a single contact implementation as described with respect to FIGS. 2A and 2B. Similarly, using the two contacts for layer 106 results in a reduction of the effective series resistance for layer 106 as compared to the series resistance of layer 106 in a single contact implementation. For example, as shown in FIG. 3B, for layer 102, the series resistance between contact 302 and node 330 and the series resistance between contact 304 and node 330 are in parallel, resulting in a reduction of the series resistance. As a result, the bandwidth of the SISCAP device 300 may be increased as compared to the SISCAP device 200.

Optical loss is impacted by optical confinement and spacing to highly doped regions (e.g., spacing 390 or spacing 392). Forming the two contact for each layer while providing optical confinement with low optical loss may be achieved by performing a partial etch of the layers 102, 106 to form a rib-type structure, as shown. As an example, layer 102 may include etched regions 380, 382. To realize the reduction of series resistance for SISCAP device 300, both contacts of each layer are driven by the same voltage (e.g., modulation signal) such that they are in parallel electrical connection. In other words, a first voltage (V1) may be applied to both contacts 302, 304, and a second voltage (V2) may be applied to both contacts 312, 314, as shown.

Doping levels also impact optical loss (e.g., impacting light absorption), free carrier mobility (e.g., resistance), and grain boundaries (e.g., resulting in light scattering). Using a relatively low resistance SiGe layer as the top layer 102 allows for reducing doping concentration for layer 102, which reduces optical loss. Moreover, the top layer 102 may be implemented as a grain enhanced SiGe poly layer to increase the bandwidth of the SISCAP with little to no impact on optical loss. Using a grain enhanced SiGe poly layer is largely compatible with current SISCAP fabrication processes, and thus, does not pose many additional complexities for fabrication. Grain enhancement generally refers to increasing the size of the grain in the semiconductor layer (e.g., SiGe poly layer). For example, the grain size for the SiGe layer may be between 0.4 microns to 10 micros.

Any suitable type of SiGe material may be used to implement layer 102. For example, layer 102 may be implemented using a bulk SiGe (e.g., crystalline, unstrained), strained SiGe (e.g., crystalline), or poly-SiGe. In some embodiments, the composition of the SiGe (e.g., poly and/or single-crystal SiGe) may be Si(1-x)Ge(x) where x is less than 25%. For x of greater than 25%, the SiGe film may begin absorbing light, increasing optical losses. Where x is less than 25%, using SiGe has little to no impact when operating with 1310 nm to 1550 nm wavelengths.

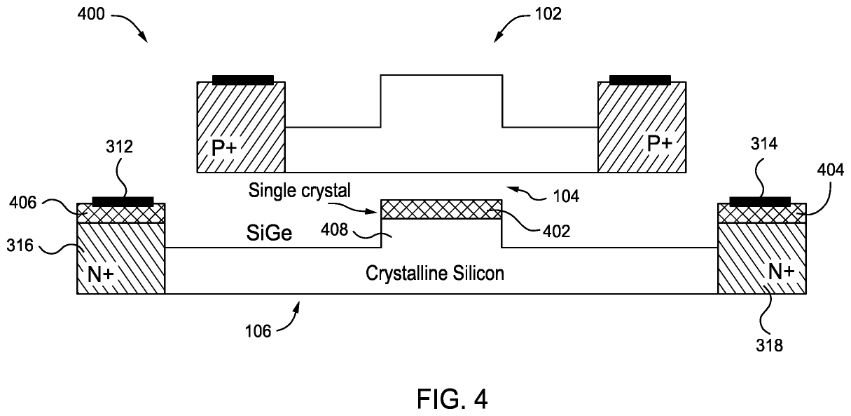

FIG. 4 illustrates another example implementation of a SISCAP device 400 having a single-crystal semiconductor layer implemented using both silicon material and SiGe material. As shown, the single-crystal semiconductor layer 106 includes SiGe material 402 adjacent to (e.g., adjoining) dielectric region 104. Moreover, the single-crystal semiconductor layer 106 includes SiGe material 406 between contact 312 and the highly negative doped region 316, and SiGe material 404 between contact 314 and the highly negative doped region 318. Since SiGe provides higher electron mobility as compared to silicon, using SiGe material 402, 404, 406 provides faster movement of charge in and out of regions of interest near the gate dielectric or contacts, improving device bandwidth. The SiGe materials may include strained single-crystal SiGe material, or unstrained single-crystal silicon germanium material. The single-crystal semiconductor layer 106 may also include a single-crystal silicon material 408, as shown.

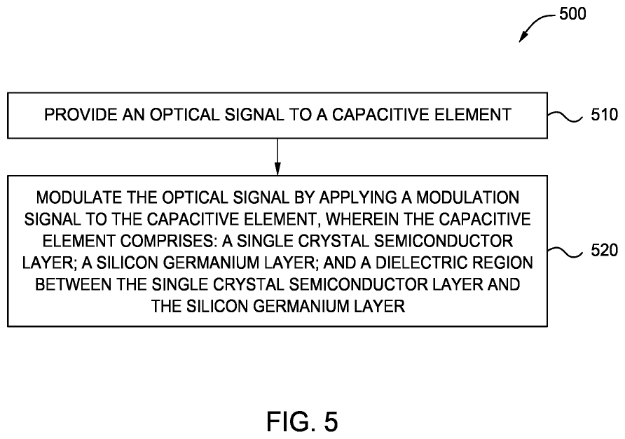

FIG. 5 is a flow diagram illustrating example operations 500 for optical modulation. The operations 500 may be performed by an optical modulation system, such as the SISCAP devices 100, 200, 300, or 400 and optical modulation component 170.

The operations 500 begin, at block 510, by the optical modulation system providing an optical signal (e.g., optical signal 108) to a capacitive element (e.g., SISCAP). At block 520, the optical modulation system modulates the optical signal by applying (e.g., via modulation component 170) a modulation signal to the capacitive element. The capacitive element may include a single-crystal semiconductor layer (e.g., layer 106), an SiGe layer (e.g., layer 102), and a dielectric region (e.g., dielectric region 104) between the single-crystal semiconductor layer and the SiGe layer.

In some embodiments, the SiGe layer is a polycrystalline SiGe layer. The single-crystal semiconductor layer and the SiGe layer are doped with opposite polarities in some embodiments. For example, the single-crystal semiconductor layer is doped negative and the SiGe layer is doped positive, in some embodiments.

In some embodiments, the SiGe layer is grain enhanced. The single-crystal semiconductor layer may include single-crystal silicon material, single-crystal silicon germanium material, or both single-crystal silicon material and single-crystal silicon germanium material, as shown in FIG. 4.

In some embodiments, the single-crystal SiGe material includes strained single-crystal silicon germanium material (or unstrained single-crystal silicon germanium material). In some embodiments, a composition of the SiGe layer or the strained or unstrained single-crystal SiGe layer includes silicon (1-x) germanium (x), where x is less than 25%.

In some embodiments, the SiGe layer includes a highly doped region (e.g., highly positive doped region 110 or 306) with a higher doping concentration than another region of the single-crystal semiconductor layer. The capacitive element further includes a contact (e.g., contact 116 or 302) coupled to the highly doped region, the modulation signal being applied to the contact.

In some embodiments, the SiGe layer also includes another highly doped region (e.g., highly positive doped region 308) with a higher doping concentration than the other region of the single-crystal semiconductor layer. In one example, the capacitive element also includes another contact (e.g., contact 304) coupled to the other highly doped region, the modulation signal being further applied to the other contact.

To facilitate understanding, identical reference numerals have been used, where possible, to designate identical elements that are common to the figures. It is contemplated that elements disclosed in one embodiment may be beneficially used in other embodiments without specific recitation.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

In view of the foregoing, the scope of the present disclosure is determined by the claims that follow.

We claim:

1. An optical modulator, comprising:
a capacitive element configured to modulate an optical signal, the capacitive element comprising:
a single-crystal semiconductor layer;
a silicon germanium layer; and
a dielectric region between the single-crystal semiconductor layer and the silicon germanium layer.

2. The optical modulator of claim 1, wherein the silicon germanium layer comprises a polycrystalline silicon germanium layer.

3. The optical modulator of claim 1, wherein the single-crystal semiconductor layer and the silicon germanium layer are doped with opposite polarities.

4. The optical modulator of claim 1, wherein the silicon germanium layer is grain enhanced.

5. The optical modulator of claim 1, wherein the single-crystal semiconductor layer comprises at least one of:
single-crystal silicon material;
single-crystal silicon germanium material; or
the single-crystal silicon material and the single-crystal silicon germanium material.

6. The optical modulator of claim 5, wherein the single-crystal silicon germanium material comprises a strained single-crystal silicon germanium material.

7. The optical modulator of claim 6, wherein a composition of the silicon germanium layer or the strained single-crystal silicon germanium material includes silicon (1-x) germanium (x), where x is less than 25%.

8. The optical modulator of claim 1, wherein:
the silicon germanium layer comprises a highly doped region having a higher doping concentration as compared to another region of the single-crystal semiconductor layer; and
the capacitive element further comprises a contact coupled to the highly doped region.

9. The optical modulator of claim 8, wherein:
the silicon germanium layer comprises another highly doped region having a higher doping concentration as compared to the other region of the single-crystal semiconductor layer; and
the capacitive element further comprises another contact coupled to the other highly doped region.

10. The optical modulator of claim 1, wherein a portion of the silicon germanium layer is adjoining a first side of the dielectric region, and wherein a portion of the single-crystal semiconductor layer is adjoining a second side of the dielectric region, the first side and the second side being opposite sides of the dielectric region.

11. A method for optical modulation, comprising:
providing an optical signal to a capacitive element; and
modulating the optical signal by applying a modulation signal to the capacitive element, wherein the capacitive element comprises:
a single-crystal semiconductor layer;
a silicon germanium layer; and
a dielectric region between the single-crystal semiconductor layer and the silicon germanium layer.

12. The method of claim 11, wherein the silicon germanium layer comprises a polycrystalline silicon germanium layer.

13. The method of claim 11, wherein the single-crystal semiconductor layer and the silicon germanium layer are doped with opposite polarities.

14. The method of claim 11, wherein the silicon germanium layer is grain enhanced.

15. The method of claim 11, wherein the single-crystal semiconductor layer comprises at least one of:
single-crystal silicon material;
single-crystal silicon germanium material; or
the single-crystal silicon material and the single-crystal silicon germanium material.

16. The method of claim 15, wherein the single-crystal silicon germanium material comprises a strained single-crystal silicon germanium material.

17. The method of claim 16, wherein a composition of the silicon germanium layer or the strained single-crystal silicon germanium material includes silicon (1-x) germanium (x), where x is less than 25%.

18. The method of claim 11, wherein:
the silicon germanium layer comprises a highly doped region having a higher doping concentration as compared to another region of the single-crystal semiconductor layer; and
the capacitive element further comprises a contact coupled to the highly doped region, the modulation signal being applied to the contact.

19. The method of claim 18, wherein:
the silicon germanium layer comprises another highly doped region having a higher doping concentration as compared to the other region of the single-crystal semiconductor layer; and
the capacitive element further comprises another contact coupled to the other highly doped region, the modulation signal being further applied to the other contact.

20. An apparatus for optical modulation, comprising:
a capacitive element having a single-crystal semiconductor layer, a silicon germanium layer, and a dielectric region between the single-crystal semiconductor layer and the silicon germanium layer;
an optical component configured to provide an optical signal to the capacitive element; and
a modulation component configured to modulate the optical signal by applying a modulation signal to the capacitive element.
